(19) United States
(12) Patent Application Publication
(10) Pub. No.: US 2026/0169822 A1
(43) Pub. Date: Jun. 18, 2026

(54) MULTI-STAGE METHOD AND APPARATUS FOR SECTOR CARRIER ASSIGNMENT

(71) Applicant: Telefonaktiebolaget LM Ericsson (publ), Stockholm (SE)

(72) Inventors: Carla MOURADIAN, Montreal (CA); Róbert SZABÓ, Budapest (HU); Wubin LI, Kirkland (CA); Ákos RECSE, Halasztelek (HU)

(73) Assignee: Telefonaktiebolaget LM Ericsson (publ), Stockholm (SE)

(21) Appl. No.: 19/127,099

(22) PCT Filed: Nov. 11, 2022
(86) PCT No.: PCT/IB2022/060883

§ 371 Date: May 2, 2025

(51) Int. Cl. G06F 9/50

(52) U.S. Cl. CPC G06F 9/5077

(57) ABSTRACT

A method and related electronic device are described for assigning computing resources to support a plurality of sector carriers of the mobile network. The method comprises acquiring information describing the computing resources, and constructing a linear programming model based at least on the information, an affinity constraint, and an anti-affinity constraint. The linear programming model includes one or more penalty terms for the affinity constraint and/or the anti-affinity constraint. The method further comprises determining whether an optimal solution exists for the model by mapping the plurality of sector carriers to electronic device(s), and mapping those sector carriers that are (i) mapped to a particular electronic device, and (ii) corresponding to at least a threshold value of the affinity constraint, to virtualization unit(s) of the virtualized resources. When the optimal solution exists, generating an assignment plan for the plurality of sector carriers corresponding to the optimal solution.

### TECHNICAL FIELD

Embodiments of the invention relate to the field of mobile networks; and more specifically, to techniques for assigning computing resources to support sector carriers in a mobile network.

### BACKGROUND ART

Cellular telecommunication networks, sometimes referred to herein as “mobile networks,” are relatively large networks encompassing a large number of electronic devices to enable other electronic devices (sometimes referred to as “user equipment” (UE) or “mobile devices”) to connect wirelessly to the mobile network. The mobile network is also typically connected to one or more other networks (e.g., the Internet). The mobile network enables the electronic devices currently connected to the mobile network to communicate over the network(s) with other electronic devices. The mobile network is designed to allow the mobile devices, e.g., mobile phones, tablets, laptops, IoT devices and similar devices, to shift connection points with the mobile network in a manner that maintains continuous connections for the applications of the mobile devices. Typically, the mobile devices connect to the mobile network via radio access network (RAN) base stations (sometimes referred to as “access points”), which provide connectivity to a number of mobile devices for a local area or “cell”. Managing and configuring the mobile network including the cells of the mobile network is an administrative challenge as each cell can have different geographic and/or technological characteristics.

In modern implementations of mobile networks, such as 5G, 6G, or beyond, a number of different resources such as radio resources and computing resources (e.g., compute, storage, transport) are provisioned to provide connections and services to a number of mobile devices. Achieving suitable performance of the mobile network, such as service availability and service assurance, may require the real-time prioritization of the different provisioned resources. The prioritization may be challenging, as a finite amount of resources are balanced with a number of competing (and sometimes contradicting) objectives while still meeting resiliency, mobility, and/or energy efficiency requirements of the mobile network. For example, in a cloud-based RAN, resources are provisioned for virtualized distributed units (DUs), centralized units providing user plane functionality (CU-UP), centralized units providing control plane functionality (CU-CP), and the routing of enhanced Common Public Radio Interface (eCPRI) traffic to the virtualized DUs in Hub sites. The cloud-based RAN may have contradicting objectives, such as a high mobility requirement that incentivizes hosting multiple virtualized DU instances on a single server, and a resiliency requirement that incentivizes hosting the multiple virtualized DU instances on different servers.

### SUMMARY

In one embodiment, a method is performed by an electronic device for assigning computing resources, provided by one or more electronic devices of a mobile network, to support a plurality of sector carriers of the mobile network. The method comprises acquiring information describing the computing resources, the computing resources including virtualized resources at one or more levels of virtualization. The method further comprises constructing a linear programming model based at least on the information, an affinity constraint between different sector carriers of pairs of the plurality of sector carriers, and an anti-affinity constraint between the different sector carriers of the pairs of the plurality of sector carriers, wherein the linear programming model includes one or more penalty terms corresponding to one or both of the affinity constraint and the anti-affinity constraint. The method further comprises determining whether an optimal solution exists for the linear programming model. Determining whether the optimal solution exists comprises mapping the plurality of sector carriers to a first set of the one or more electronic devices, and mapping those sector carriers of the plurality of sector carriers that are (i) mapped to a particular electronic device of the first set, and (ii) corresponding to at least a threshold value of the affinity constraint, to a second set of one or more virtualization units of the virtualized resources. The method further comprises, when the optimal solution exists, generating an assignment plan for the plurality of sector carriers corresponding to the optimal solution.

In another embodiment, an electronic device comprises a machine-readable medium comprising computer program code, and one or more processors to execute the computer program code to perform operations for assigning computing resources, provided by one or more electronic devices of a mobile network, to support a plurality of sector carriers of the mobile network. The operations comprise acquiring information describing the computing resources, the computing resources including virtualized resources at one or more levels of virtualization. The operations comprise constructing a linear programming model based at least on the information, an affinity constraint between different sector carriers of pairs of the plurality of sector carriers, and an anti-affinity constraint between the different sector carrier of the pairs of the plurality of sector carriers, wherein the linear programming model includes one or more penalty terms corresponding to one or both of the affinity constraint and the anti-affinity constraint. The operations further comprise determining whether an optimal solution exists for the linear programming model. Determining whether the optimal solution exists comprises mapping the plurality of sector carriers to a first set of the one or more electronic devices, and mapping those sector carriers of the plurality of sector carriers that are (i) mapped to a particular electronic device of the first set, and (ii) corresponding to at least a threshold value of the affinity constraint, to a second set of one or more virtualization units of the virtualized resources.

The operations further comprise, when the optimal solution exists, generating an assignment plan for the plurality of sector carriers corresponding to the optimal solution.

### BRIEF DESCRIPTION OF THE DRAWINGS

The invention may best be understood by referring to the following description and accompanying drawings that are used to illustrate embodiments of the invention. In the drawings:

FIG. 1 illustrates a method performed by an electronic device for assigning computing resources to support a plurality of sector carriers of a mobile network, according to one or more embodiments.

FIG. 2 illustrates an exemplary mobile network, according to one or more embodiments.

FIG. 3 illustrates an exemplary linear programming model for assigning computing resources to sector carriers of a mobile network, according to one or more embodiments.

FIG. 4 illustrates an exemplary hierarchy of computing resources including virtualized resources at one or more levels of virtualization, according to one or more embodiments.

FIG. 5A illustrates an exemplary assignment of computing resources to support a plurality of sector carriers of a mobile network, according to one or more embodiments.

FIG. 5B illustrates an exemplary assignment of computing resources to support a plurality of sector carriers of a mobile network, according to one or more embodiments.

FIG. 6A illustrates connectivity between network devices (NDs) within an exemplary network, as well as three exemplary implementations of the NDs, according to one or more embodiments.

FIG. 6B illustrates an exemplary way to implement a special-purpose network device according to one or more embodiments.

FIG. 6C illustrates various exemplary ways in which virtual network elements (VNEs) may be coupled according to one or more embodiments.

FIG. 6D illustrates a network with a single network element (NE) on each of the NDs, and within this straightforward approach contrasts a traditional distributed approach (commonly used by traditional routers) with a centralized approach for maintaining reachability and forwarding information (also called network control), according to one or more embodiments.

FIG. 6E illustrates the simple case of where each of the NDs implements a single NE, but a centralized control plane has abstracted multiple of the NEs in different NDs into (to represent) a single NE in one of the virtual network(s), according to one or more embodiments.

FIG. 6F illustrates a case where multiple VNEs are implemented on different NDs and are coupled to each other, and where a centralized control plane has abstracted these multiple VNEs such that they appear as a single VNE within one of the virtual networks, according to one or more embodiments.

FIG. 7 illustrates a general purpose control plane device with centralized control plane (CCP) software, according to one or more embodiments.

FIG. 8 illustrates a method performed by an electronic device for determining whether an optimal solution exists for the linear programming model, according to one or more embodiments.

FIG. 9 illustrates a two-stage implementation of an optimization solver, according to one or more embodiments.

FIG. 10A illustrates an assignment of sector carriers using an exemplary two-stage optimization, according to one or more embodiments.

FIG. 10B illustrates an assignment of sector carriers using an exemplary one-stage optimization, according to one or more embodiments.

### DETAILED DESCRIPTION

The following description describes methods and apparatus for assigning computing resources, provided by one or more electronic devices of a mobile network, to support a plurality of sector carriers of the mobile network. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

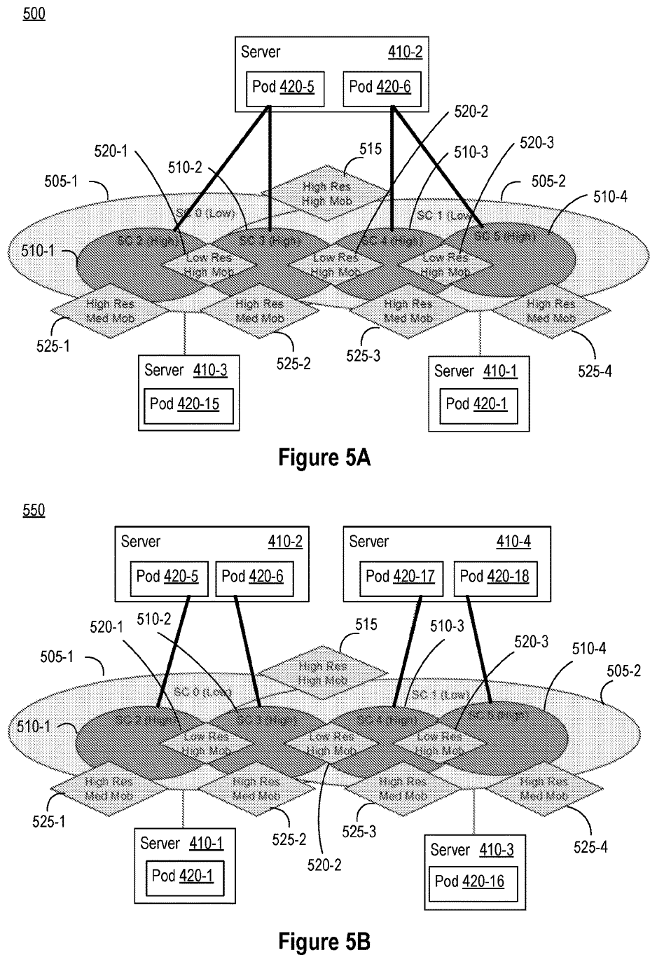

In various embodiments described herein, the sector carrier assignment problem may be modeled as an offline optimization problem using linear programming. More specifically, the assignment of multiple levels of computing resources (e.g., including virtualized resources at one or more levels of virtualization) may be modeled as a hierarchical bin packing problem, as illustrated in FIG. 4 and discussed in greater detail below. In an exemplary hierarchical bin packing problem, sector carriers of the mobile network are assigned to virtualized DUs, and the virtualized DUs are assigned to containers (one example of virtualization units) of physical servers (one example of physical computing units).

The linear programming model may consider a number of different constraints that are competing with (and sometimes contradicting) each other. The constraints are implemented as zero or more “hard” constraints (required to be satisfied at all times) and one or more “soft” constraints (which should be satisfied as much as possible). If the soft constraint(s) are not satisfied, one or more penalty terms are added to the objective function of the linear programming model.

In some embodiments, the linear programming model reflects one or more affinity constraints and one or more anti-affinity constraints. In the examples discussed herein, the affinity constraint represents a mobility requirement between different sector carriers, and the anti-affinity constraint represents a resiliency requirement between different sector carriers.

However, the affinity constraint and the anti-affinity constraint are contemplated as representing one or more other requirements, which may be in combination with the mobility requirement and/or the resiliency requirement. For example, the affinity constraint may (also) represent an energy efficiency requirement, the anti-affinity constraint may (also) represent a load-spreading requirement, and so forth.

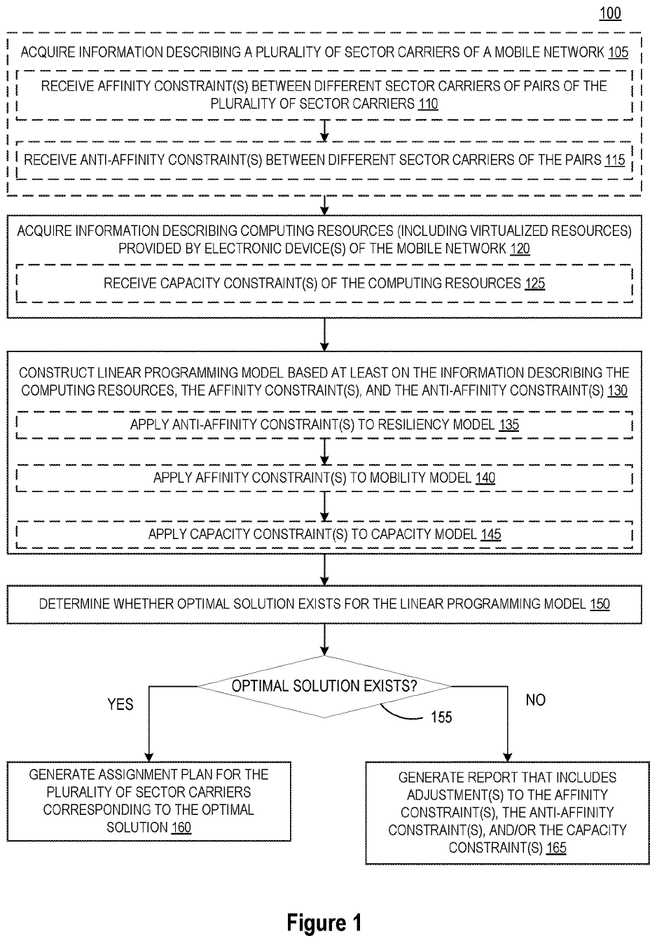

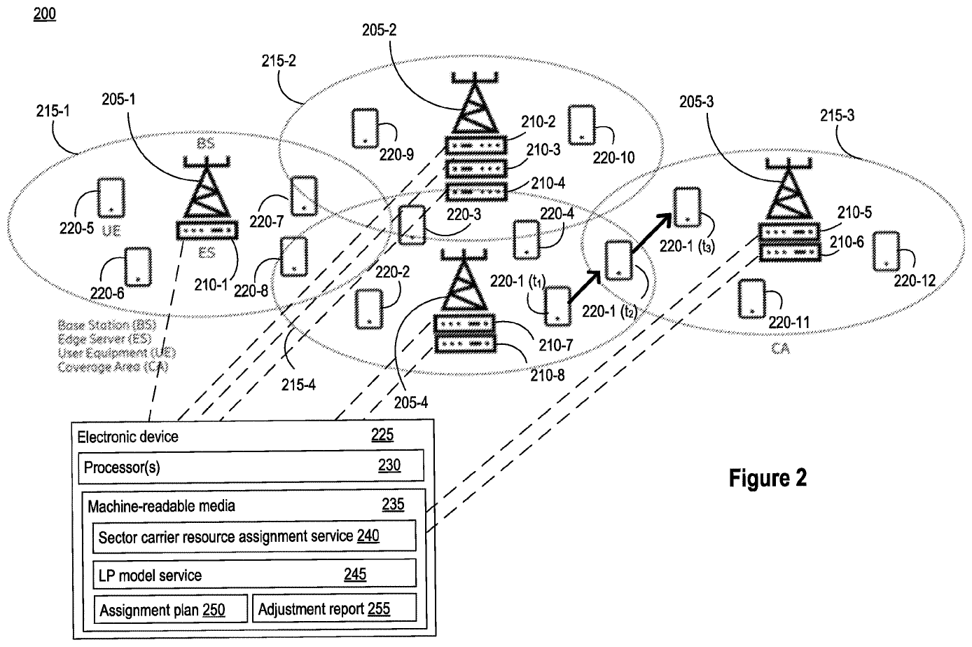

FIG. 1 illustrates a method 100 performed by an electronic device for assigning computing resources to support a plurality of sector carriers of a mobile network, according to one or more embodiments. The method 100 may be used in conjunction with other embodiments, such as being performed using hardware and/or software of an electronic device 225 shown in the mobile network 200 of FIG. 2.

As used herein, an electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors each having one or more processor cores (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

The method 100 will be described with reference to the mobile network 200, which illustrates the electronic device 225 including a sector carrier resource assignment service 240 and a linear programing (LP) model service 245. The mobile network 200 is depicted in a simplified form for the sake of illustration. The person of ordinary skill in the art will appreciate that the mobile network 200 may include numerous additional electronic devices, functions, and components that would be involved in the operation of the mobile network 200. The mobile network 200 can implement any communication technology such as 3G, 4G, 5G (e.g., as defined by 3GPP) technologies or similar technologies.

The mobile network 200 comprises a plurality of edge servers 210-1, 210-2, . . . , 210-8 (generically or collectively, edge server(s) 210). Each of the edge servers 210-1, 210-2, . . . , 210-8 may be implemented using any type or combination of electronic device(s) that provide computing resources at, or in combination with, access points to the mobile network 200 such as a respective RAN base station 205-1, 205-2, 205-3, 205-4 (also referred to as “base stations”) of the mobile network 200. The edge servers 210-1, 210-2, . . . , 210-8, the base stations 205-1, 205-2, 205-3, 205-4, and/or other electronic devices, functions, and components of the RAN can enable wireless connections with a number of mobile devices 220-1, 220-2, . . . , 220-12 (generically or collectively, mobile device(s) 220) that use the services of the mobile network 200.

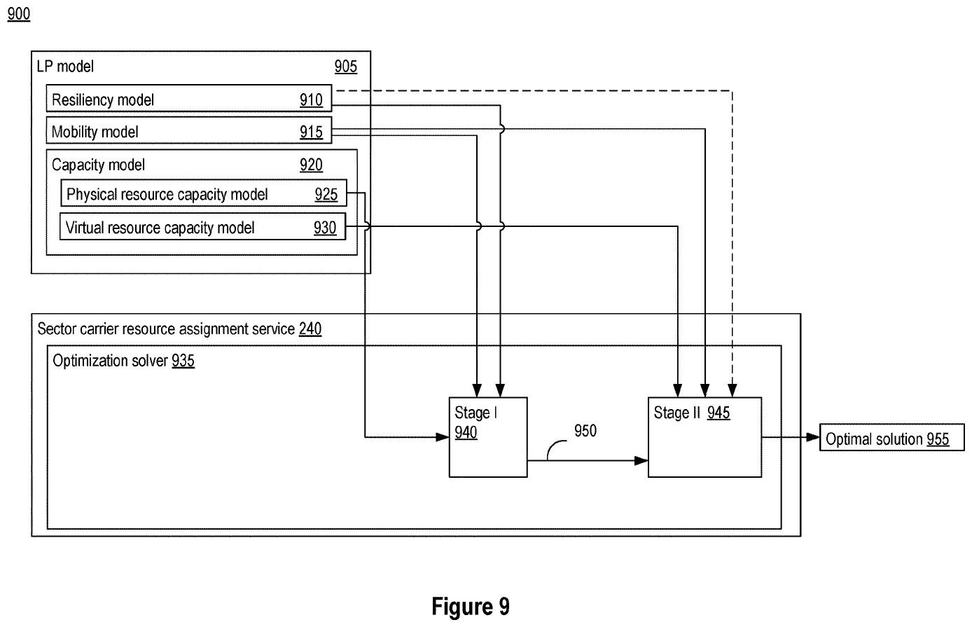

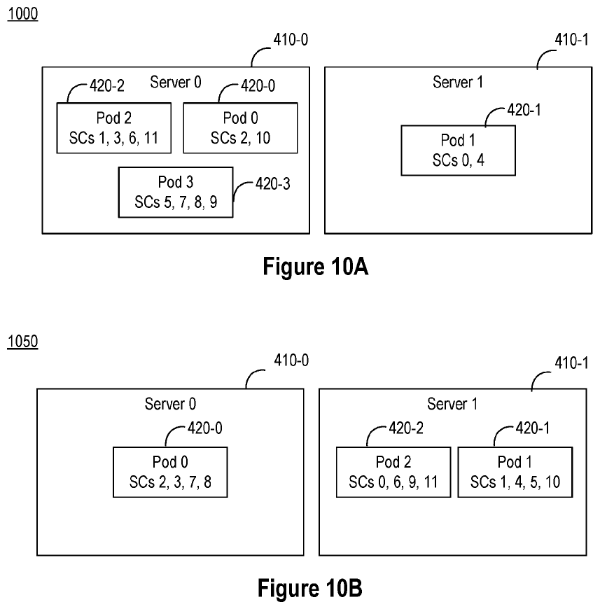

The edge servers 210-1, . . . , 210-8 are implemented using one or more electronic devices of the mobile network 200. In some embodiments, the electronic device(s) are implemented as dedicated edge server(s) 210. In some embodiments, the electronic device(s) provide the edge server(s) 210 as services (e.g., implemented as virtual network elements). Additional implementation details are discussed below with respect to FIGS. 9A-9F and 10. As shown in the mobile network 200, the edge server 210-1 is connected to the base station 205-1 having a coverage area 215-1. The edge servers 210-2, 210-3, 210-4 are connected to the base station 205-2 having a coverage area 215-2. The edge servers 210-5, 210-6 are connected to the base station 205-3 having a coverage area 215-3. The edge servers 210-7, 210-8 are connected to the base station 205-4 having a coverage area 215-4. Based on the relative locations and the operational characteristics of the base stations 205-1, 205-2, 205-3, 205-4, the coverage areas 215-1, 215-2, 215-3, 215-4 (generically or collectively, coverage area(s) 215) are arranged to have some overlap with each other.

The mobile devices 220 as shown are distributed within the coverage areas 215-1, 215-2, 215-3, 215-4. As the mobile devices 220 are mobile in nature, the mobile devices 220 are expected to transit various ones of the coverage areas 215-1, 215-2, 215-3, 215-4. Further, the mobile devices 220 at times may be within coverage area(s) 215 associated with multiple ones of the edge servers 210-1, . . . , 210-8 at a given time (e.g., within a single coverage area 215-1, 215-2, . . . , 215-4 that is associated with multiple edge servers 210-1, . . . , 210-8, or located in an overlapping region of the coverage areas 215-1, 215-2, 215-3, 215-4). For example, a first mobile device 220-1 at a first time t₁ is within the coverage area 215-4, and travels such that the first mobile device 220-1 is in overlapping coverage areas 215-3, 215-4 at a second time t₂, and in the coverage area 215-3 at a third time t₃.

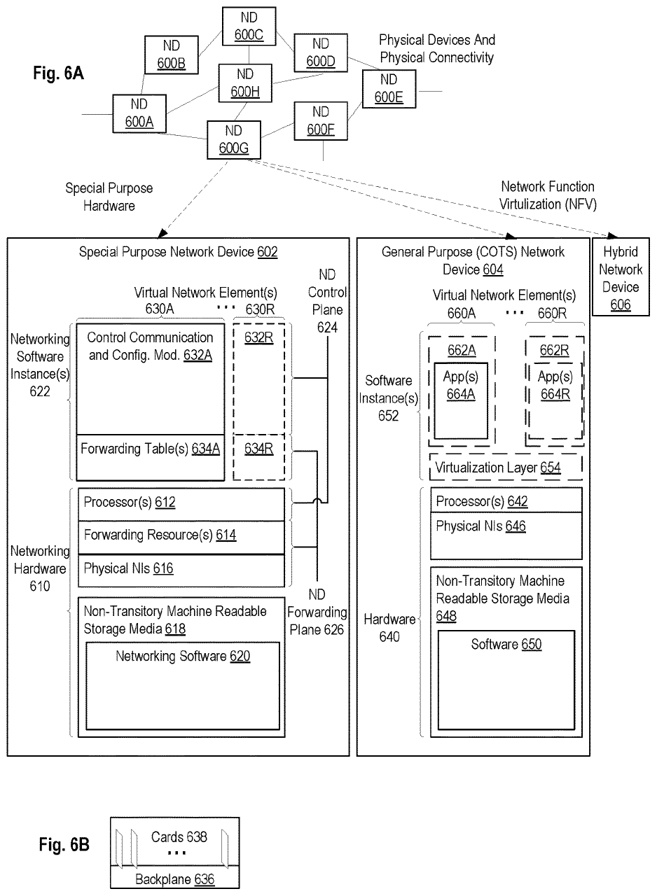

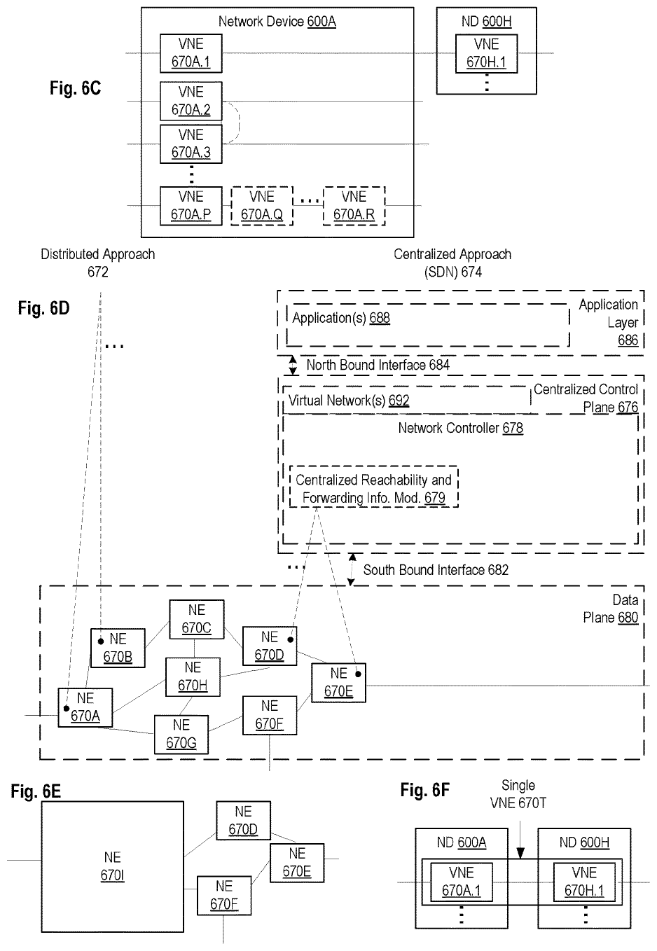

Within the coverage areas 215-1, 215-2, 215-3, 215-4, each of the RAN base stations 205-1, 205-2, 205-3, 205-4 operates to provide a respective one or more sector carriers corresponding to one or more spectrum bands. For example, assuming that the mobile network 200 is a 5G network, the RAN base stations 205 may be operated to provide sector carriers corresponding to one or more “low” bands (e.g., frequencies less than 1 gigahertz (GHz)), one or more “mid” bands (e.g., frequencies between 1-2.6 GHz and/or 3.5-6 GHz), and/or one or more “high” bands (frequencies between 24-40 GHz). The configuration of the RAN base stations 205 (e.g., specifying the number and/or spectrum bands of the sector carriers) may be determined to provide a desired service availability and/or performance for the mobile device(s) 220. Some examples of the sector carriers are illustrated in FIGS. 5 and 6 and discussed in greater detail below. The person of ordinary skill will understand the RAN base stations 205 may provide any other suitable numbers of sector carriers, which may correspond to any different spectrum bands.

As previously described, while electronic devices may include a number of components, FIG. 2 shows the electronic device 225 as comprising one or more processors 230 and machine-readable media 235 for simplicity. While depicted as a single element within the electronic device 225, the one or more processors 230 contemplates a single processor, multiple processors, a processor or processors having multiple cores, as well as combinations thereof. In one embodiment, the one or more processors 230 comprises a host central processing unit (CPU) of the electronic device 225.

The machine-readable media, such as machine-readable media 235, may include a variety of media selected for relative performance or other capabilities: volatile and/or non-volatile media, removable and/or non-removable media, etc. Thus, the machine-readable media 235 may include cache, random access memory (RAM), storage, etc. Storage included in the machine-readable media 235 typically provides a non-volatile memory for the electronic device 225, and may include one or more different storage elements such as Flash memory, a hard disk drive, a solid state drive, an optical storage device, and/or a magnetic storage device. In some embodiments, the machine-readable media 235 stores a sector carrier resource assignment service 240 and a linear programming (LP) model service 245, each representing code that is executed by the one or more processors 230 to implement various functionality described herein.

As discussed above, the assignment of multiple levels of computing resources (e.g., including virtualized resources at one or more levels of virtualization) may be modeled as a hierarchical bin packing problem, where sector carriers of the mobile network 200 are assigned physical resources and/or virtual resources provided by electronic device(s) (e.g., various ones of the edge servers 210) of the mobile network 200. In some embodiments, each request for a sector carrier is assigned to a selected edge server 210 of the plurality of edge servers 210 of the mobile network 200, as well as a software instance (e.g., a container or a pod) running on the selected edge server 210, which can host multiple software instances.

In some embodiments, the sector carrier resource assignment service 240 acquires information describing a plurality of sector carriers of the mobile network 200, and/or information describing the computing resources provided by the electronic device(s) of the mobile network 200. The LP model service 245 constructs a LP model based the acquired information, an affinity constraint between different sector carriers of pairs of the plurality of sector carriers, and an anti-affinity constraint between the different sector carriers of the pairs of the plurality of sector carriers. The LP model includes one or more penalty terms corresponding to one or both of the affinity constraint and the anti-affinity constraint.

The sector carrier resource assignment service 240 determines whether an optimal solution exists for the LP model. The sector carrier resource assignment service 240 generates an assignment plan 250 corresponding to the optimal solution (when the optimal solution is determined to exist), and/or an adjustment report 255 that includes one or more adjustments to one or more of: the affinity constraint, the anti-affinity constraint, and the capacity constraint that would permit an optimal solution to exist. In some embodiments, the sector carrier resource assignment service 240 also communicates the assignment plan to a deployment service to deploy the assignment plan and thereby configure the electronic device(s) (e.g., the edge servers 210) of the mobile network 200 to support the set of sector carriers.

Returning to FIG. 1, the method 100 begins at optional block 105, where the electronic device 225 acquires information describing a plurality of sector carriers of the mobile network 220. The information may be provided in any suitable form. For example, the information may be provided to the electronic device 225 as a sector carrier assignment request. In some embodiments, acquiring the information comprises, at optional block 110, receiving one or more affinity constraints between different sector carriers of pairs of the plurality of sector carriers. In some embodiments, acquiring the information comprises, at optional block 115, receiving one or more anti-affinity constraints between different sector carriers of the pairs of the plurality of sector carriers. The affinity constraints and/or the anti-affinity constraints may be “hard” constraints (required to be satisfied at all times) and/or “soft” constraints (which should be satisfied as much as possible). If the soft constraint(s) are not satisfied, one or more penalty terms are added to the objective function of the linear programming model.

The affinity constraints and/or anti-affinity constraints may be provided in any suitable form. In one example, the affinity constraints and/or anti-affinity constraints correspond to one or more discrete levels of requirements (e.g., low, medium, and high mobility, low, medium, and high resiliency). The values of the affinity constraints and/or anti-affinity constraints may be selected based on different types of sector carriers (e.g., a same value is applied for pairs of sector carriers having a same type or pair of types) or specific to each pairing of the sector carriers (e.g., each distinct pair of sector carriers may be given a different value).

At block 120, the electronic device 225 acquires information describing computing resources provided by one or more electronic devices of the mobile network. In some embodiments, the computing resources include physical resources provided by the one or more electronic devices, as well as virtualized resources provided at one or more levels of virtualization. In one non-limiting example, the physical resources may include (1) a plurality of hubs, and (2) a plurality of servers, where each hub is connected with one or more of the servers; and the virtualized resources may include (1) a plurality of virtual machines (VMs) hosted on various ones of the servers, and (2) a plurality of pods (or containers) implemented on particular servers and/or particular VMs.

In some embodiments, acquiring the information comprises, at optional block 125, receiving one or more capacity constraints of the computing resources. In one non-limiting example, each server has a maximum capacity of two (2) pods, and each pod has a maximum capacity of two (2) sector carriers (such that each server may support up to four (4) carriers). Other values of the capacity constraints are also contemplated.

Refer now to diagram 400 of FIG. 4, which illustrates an exemplary hierarchy of computing resources including virtualized resources at one or more levels of virtualization, according to one or more embodiments. The features shown in the diagram 400 may be used in conjunction with other embodiments, e.g., representing the computing resources provided by one possible implementation of the mobile network 200 of FIG. 2.

In the diagram 400, the hierarchy includes a hub 405-1, a plurality of n servers 410-1, 410-2, . . . , 410-n that are each connected with the hub 405-1, and a plurality of pods 420-1, 420-2, . . . , 420-8 implemented using various ones of the plurality of servers 410-1, 410-2, . . . , 410-n.

In some embodiments, the hierarchy further includes another hub 405-2 that is arranged at a same level at the hub 405-1, and a second plurality of m servers 410-(n+1), . . . , 410-(n+m) that are each connected with the hub 405-2, and a second plurality of pods 420-9, . . . , 420-14 implemented on various ones of the second plurality of servers 410-(n+1), . . . , 410-(n+m). The hierarchy further includes a hub 402-1 that is arranged at a higher level than the hubs 405-1, 405-2 and that connects to the hubs 405-1, 405-2. In some cases, the hub 402-1 may provide a supervisory functionality to the hubs 405-1, 405-2 (e.g., coordinating and/or controlling operation).

In some embodiments, the hierarchy further includes a plurality of VMs 415-1, . . . 415-4 that are hosted on the respective servers 410-1, 410-(n+1). In such embodiments, some or all of the plurality of pods 420-1, 420-2, . . . , 420-8 and the second plurality of pods 420-9, . . . , 420-14 are implemented on the VMs 415-1, . . . , 415-4. In this way, the virtualized resources provided by the electronic devices of the mobile network may be provided at multiple levels of virtualization (with the VMs 415-1, . . . , 415-4 representing a first level, and the pods 420-1, . . . , 420-14 that are implemented on the VMs 415-1, . . . , 415-4 representing a second level). In alternate embodiments, all of the pods 420-1, . . . , 420-14 are implemented directly on the respective servers 410-1, . . . , 410-(n+m) (that is, without an intermediate virtualization level). Such a hierarchy may be represented using different forms of variables in the LP model. For example, the LP model may include X[i, j, k]=1 to indicate that a sector carrier k is hosted in a VM j which is on a server i, and may also include Y[i, j]=1 to indicate that a sector carrier j is directly hosted on a server i.

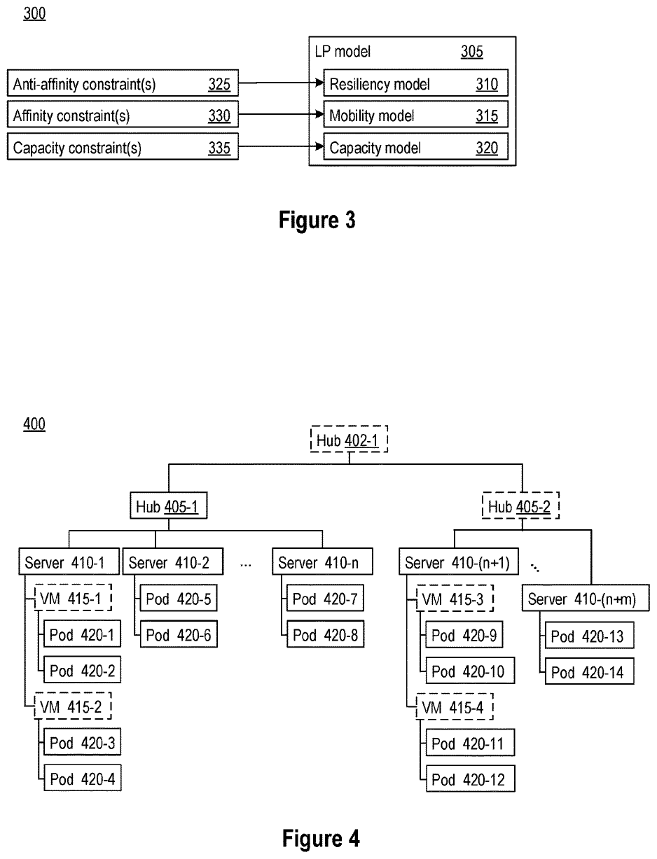

Returning to FIG. 1, at block 130, the electronic device 225 constructs a linear programming model based on at least the information describing the computing resources, the one or more affinity constraints, and the one or more anti-affinity constraints. Referring also to diagram 300 of FIG. 3, in some embodiments the linear programming model 305 comprises a resiliency model 310, a mobility model 315, and a capacity model 320. Alternate implementations of the linear programming model 305 having different compositions of models, which may include different types of models, are also contemplated.

In some embodiments constructing the linear programming model 305 comprises, at optional block 135, applying the one or more anti-affinity constraints 325 to the resiliency model 310. At optional block 140, the one or more affinity constraints 330 are applied to the mobility model 315. At optional block 145, the one or more capacity constraints 335 are applied to the capacity model 320.

In some embodiments, the LP model 305 includes one or more decision variables for each of the sector carriers of the plurality of sector carriers of the mobile network 200. For example, the decision variable may be represented as a binary parameter:

$${x}_{s , p}^{SC} ∈ \{ 0 , 1 \} \qquad ( 1 )$$

which indicates whether the sector carrier SC is assigned to a particular pod p and a particular server s.

The sector carriers are subject to multiple constraints, such as affinity constraint(s) and anti-affinity constraint(s) defined between pairs of sector carriers of the plurality of sector carriers. As discussed above, the affinity constraint(s) represent a mobility requirement(s) between different sector carriers, and the anti-affinity constraint(s) represent a resiliency requirement(s) between different sector carriers.

In some embodiments, the affinity constraint(s) are modeled as soft constraints, and the anti-affinity constraint(s) are modeled as soft constraints and/or hard constraints. In one example, when the resiliency requirement(s) are relatively few (or sparse), the corresponding anti-affinity constraint(s) may be modeled as hard constraints. In another example, resource utilization may also be a concern, and the anti-affinity constraint(s) may be modeled as soft constraints. recommend using soft constraints for resiliency too. For the mobility requirement(s), the requirement matrix is typically denser such that it may be preferable to model the affinity constraint(s) as soft constraints.

Generally, a penalty term is added to the objective function of the LP model 305 for each sector carrier assignment, and the penalty term is greater where the affinity constraint(s) and/or anti-affinity constraint(s) are not met. The objective function of the LP model 305 may be modeled as a minimization problem.

As discussed above, the affinity constraint(s) and/or the anti-affinity constraint(s) correspond to one or more discrete levels of requirements. In some embodiments, and in the example implementations described herein, the resiliency requirement has two levels: a “high” resiliency indicating that the SCs of the pair should be placed on different servers, and a “low” resiliency indicating that the SCs of the pair may be placed on the same server or on different servers.

In one implementation of the resiliency model 310, the resiliency requirement is modeled as a soft anti-affinity constraint. Where a “high” resiliency is required, the SCs of the pair should be assigned to different servers. When the SCs are assigned to the same server, indicating that the resiliency requirement is not met, then a large penalty term is added to the objective function. If the SCs are assigned to different servers, indicating that the resiliency requirement is satisfied, then a small penalty term is added to the objective function. This may be referred to as a “group penalty method” and may be performed as follows.

In the resiliency model 310, the two SCs with a high resiliency requirement may be defined as SCₙ and SCₘ, and an integer decision variable reqₛₑᵣᵥₑᵣ_{_{R}} representing the number of servers assigned to SCₙ and SCₘ may be included in the objective function. More specifically:

$$r e {q}_{{server}_{R}} \geq - ( {\sum }_{{∀ i ϵ servers}_{∀ j ϵ pods}} {x}_{i , j}^{{SC}_{n}} + {x}_{i , j}^{{SC}_{m}} ) \qquad ( 2 )$$

$${r eq}_{{server}_{R}} \geq - 1 \qquad ( 3 )$$

$$obj += re {q}_{{server}_{R}} * ( - pR ) \qquad ( 4 )$$

where obj+=represents a penalty term that is added to the objective function and pR is a positive value. In some cases, pR may be assigned different values based on a priority of the resiliency requirement relative to other requirements (e.g., greater or lesser priority than a mobility requirement). Thus, when SCₙ and SCₘ are assigned to the same server, a negative penalty term of (1*−pR) is added to the objective function. If SCₙ and SCₘ are assigned to different servers, the resiliency requirement is satisfied, a negative penalty term of (2*(−pR)) is added to the objective function, indicating a smaller penalty term.

In another implementation of the resiliency model 310, the resiliency requirement is modeled as a hard anti-affinity constraint. Where a “high” resiliency is required, the SCs of the pair are assigned to different servers. Thus, for any server i and pod j:

$${\sum }_{{∀ i ϵ servers}_{∀ j ϵ pods}} {x}_{i , j}^{{SC}_{n}} + {x}_{i , j}^{{SC}_{m}} \leq 1 \qquad ( 5 )$$

In one implementation of the mobility model 315, the mobility requirement is modeled as a soft affinity constraint. In some embodiments, and in the example implementations described herein, the mobility requirement has three levels: a “high” mobility indicating that the SCs of the pair should be implemented using a same software instance (e.g., a same pod) on a same server, a “medium” mobility indicating that the SCs of the pair should share a same server but need not share the same software instance, and a “low” mobility indicating that the SCs of the pair need not share the same server or the same software instance.

In some embodiments, a penalty term may be applied for violations of the high mobility and medium mobility requirements, but not for the low mobility requirement. For example, where a high mobility or a medium mobility is required, the SCs of the pair should be assigned to a same server and/or a same software instance. For the high mobility case, when the SCs are assigned to different servers or to different software instances, indicating that the mobility requirement is not satisfied, then a large penalty term is added to the objective function. If the SCs are assigned to a same server and a same software instance, indicating that the mobility requirement is satisfied, then a small penalty term is added to the objective function.

In the mobility model 315, the two SCs with a high mobility requirement or a medium mobility requirement are again defined as SCₙ and SCₘ and an integer decision variable reqₛₑᵣᵥₑᵣ_{_{M}} representing the number of servers assigned to SCₙ and SCₘ may be included in the objective function. More specifically:

$$r e {q}_{{server}_{M}} \geq {\sum }_{∀ j ϵ pods} {x}_{s , j}^{{SC}_{n}} * p {M}_{s} \qquad ( 6 )$$

$${req}_{{server}_{M}} \geq {\sum }_{∀ j ϵ pods} {x}_{s , j}^{{SC}_{m}} * p {M}_{s} \qquad ( 7 )$$

$$obj += {req}_{{server}_{R}} \qquad ( 8 )$$

where obj+=represents a penalty term that is added to the objective function and pMₛ is a positive value. In some cases, pMₛ may be assigned different values based on a priority of the mobility requirement relative to other requirements (e.g., greater or lesser priority than a resiliency requirement). Thus, when SCₙ and SCₘ are assigned to different servers the mobility requirement is not satisfied, then a penalty value of (pMₛ) is added twice to the objective function. If SCₙ and SCₘ are assigned to the same server, the mobility requirement is satisfied, then pMₛ is added once to the objective function, indicating a smaller penalty term.

In the mobility model 310, for a high mobility requirement the two SCs with should also be assigned to a same software instance (e.g., a pod) on a same server. If the two SCs are not assigned to the same pod, the high mobility requirement is not satisfied, a large penalty term is added to the objective function. If the two SCs are assigned to the same pod, the high mobility requirement is satisfied and a small penalty term is added to the objective function.

In the mobility model 315, an integer decision variable req_{pod}_{_{M}} representing the number of pods assigned to SCₙ and SCₘ may be included in the objective function. More specifically:

$$r e {q}_{{pod}_{M}} \geq {x}_{s , p}^{{SC}_{n}} * {pM}_{p} \qquad ( 9 )$$

$$re {q}_{{pod}_{M}} \geq {x}_{s , p}^{{SC}_{m}} * {pM}_{p} \qquad ( 10 )$$

$$obj += re {q}_{{pod}_{M}} \qquad ( 11 )$$

where obj+=represents a penalty term that is added to the objective function and pMₚ is a positive value. In some cases, pMₚ may be assigned different values based on a relative priority of the mobility requirement. Thus, when SCₙ and SCₘ are assigned to the same pod and the same server, a penalty value of (pMₚ) is added to the objective function. If SCₙ and SCₘ are assigned to different pods, then the penalty value of pMₚ is added twice to the objective function, indicating a larger penalty term. Notably, in the high mobility case, the mobility model 315 may omit checking whether the SCs are assigned to the same pod when the SCs are assigned to different servers, as the high mobility requirement has not been satisfied.

In the capacity model 320, a capacity constraint for each server may be specified in terms of a number of pods supported, processing capacity (e.g., a total number of CPUs, a number of CPUs that may be allocated), and so forth. A capacity constraint for each pod may be specified in terms of a number of SCs supported, processing capacity (e.g., an amount of processing capacity available to the pod, an amount of processing capacity that may be allocated).

The LP model 305 also ensures that each SC is assigned to only one pod and one server:

$${\sum }_{{∀ i ϵ servers}_{∀ j ϵ pods}} {x}_{i , j}^{{SC}_{n}} = 1 ∀ {SC}_{n} ∈ SCs \qquad ( 12 )$$

Thus, the objective function of the LP model 305 seeks to minimize the penalty function for violating high mobility and medium mobility requirements. In the cases where the resiliency requirement is also modeled as a soft constraint, then the objective function also seeks to minimize the penalty function for violating high resiliency requirements.

Returning to FIG. 1, at block 150, the electronic device 225 (and more specifically, the sector carrier resource assignment service 240) determines whether an optimal solution exists for the LP model 305. When the optimal solution exists (block 155; “Yes”), the method 100 proceeds from block 155 to block 160, where the electronic device 225 (and more specifically, the sector carrier resource assignment service 240) generates an assignment plan for the plurality of sector carriers corresponding to the optimal solution. In some embodiments, the electronic device 225 further transmits the assignment plan to a deployment service (not shown) that deploys the sector carriers according to the assignment plan.

When the optimal solution does not exist (block 155; “No”), the method 100 proceeds from block 155 to block 165, where the electronic device 225 generates a report that includes one or more adjustments to one or more of: the one or more affinity constraints, the one or more anti-affinity constraints, and the capacity constraint that would permit an optimal solution to exist. In some embodiments, the one or more adjustments include adjusting a hard constraint to a soft constraint, adjusting the relative priority of the resiliency or mobility requirements, adding extra resources to meet capacity demand, and/or adjusting the penalty values of the resiliency model 310, the mobility model 315, and/or the capacity model 320. The method 100 ends following completion of block 160 or block 165.

Performing the method 100 using the electronic device 225 provides a number of advantages. For example, by transforming the sector carrier resource assignment problem into the LP model 305 that is based on the computing resource information, competing constraints (e.g., affinity constraint(s) and anti-affinity constraint(s)), and/or the information describing the sector carriers of the mobile network 200, an optimal solution may be determined for many configurations of servers and pods in the mobile network 200. Notably, the optimal solution reflects both resource availability and service-related requirements. The computing resources needed to support the sector carriers can be defined per demand (e.g., sector load), and any preferences about prioritization of the different requirements can be flexibly configured. The LP model 305 accommodates the usage of capacity limits, connection limits, or configurable combinations of both at the server and pod level.

Using the resource assignment according to the optimal solution reduces the number of servers that are required to support the sector carriers of the mobile network 200. In some cases, this can result in a lower cost implementation of the mobile network 200, using fewer servers and/or less expensive servers (e.g., offering fewer computing resources). A reduced number of servers also results in a reduced energy consumption of the mobile network 200, which may also reduce operating costs. Use of the LP model 305 may require fewer computing resources (e.g., CPU cycles, memory) to produce optimal solutions when compared to existing approaches such as mixed-integer (linear) programming models, which may further reduce the energy consumption of the mobile network 200. Use of the LP model 305 may allow the optimal solutions to be produced more quickly than existing approaches, making the LP model 305 more suitable for the dynamic capabilities of the mobile network 200.

FIG. 5A illustrates an exemplary assignment of computing resources to support a plurality of sector carriers of a mobile network, according to one or more embodiments. The features in diagram 500 may be used in conjunction with other embodiments, for example, using the hierarchy of computing resources shown in FIG. 4.

As discussed above, the mobile network may support a plurality of sector carriers, at least some of which provide overlapping coverage with each other to enable mobile devices to maintain a continuous connection to the mobile network as the mobile device traverses the mobile network. In some embodiments, the plurality of sector carriers comprises one or more first sector carriers 510-1, . . . , 510-4 corresponding to a first spectrum band, and one or more second sector carriers 505-1, 505-2 corresponding to a second spectrum band. Six (6) sector carriers are shown in the diagram 500: two (2) SCs 505-1, 505-2 corresponding to a first spectrum band, and four (4) SCs 510-1, . . . , 510-4 corresponding to a second spectrum band. The first spectrum band is a lower frequency band than the second frequency band. For example, the first spectrum band may correspond to frequencies less than 1 GHz and the second spectrum band may correspond to frequencies between 24-40 GHz.

Each pair of adjacent sector carriers (e.g., partly or fully overlapping with each other) has a corresponding set of requirements, such as a resiliency requirement and a mobility requirement. In some embodiments, the levels of the resiliency requirement and the mobility requirement (or the corresponding values of the affinity constraints and/or anti-affinity constraints) in each set of requirements may be based on the type or types of sector carriers included in each pair. In other embodiments, the levels (or values) may be specific to each pair.

As shown, a set of requirements 515 exists between adjacent “low band” SCs 505-1, 505-2 (high resiliency, high mobility). Between adjacent SCs of the “high band” SCs 510-1, . . . 510-4, a set of requirements 520-1 exists between the SCs 510-1, 510-2 (low resiliency, high mobility), a set of requirements 520-2 exists between the SCs 510-2, 510-3 (low resiliency, high mobility), and a set of requirements 520-3 exists between the SCs 510-3, 510-4 (low resiliency, high mobility). For pairs of adjacent SCs between the low band and the high band, a set of requirements 525-1 exists between the SCs 505-1, 510-1 (high resiliency, medium mobility), a set of requirements 525-2 exists between the SCs 505-1, 510-2 (high resiliency, medium mobility), a set of requirements 525-3 exists between the SCs 505-2, 510-3 (high resiliency, medium mobility), and a set of requirements 525-4 exists between the SCs 505-2, 510-4 (high resiliency, medium mobility).

In the example shown in the diagram 500, the mobility requirement corresponds to a soft affinity constraint and the resiliency requirement corresponds to a hard anti-affinity constraint. Each server has a maximum capacity of two (2) pods, and each pod has a maximum capacity of two (2) SCs.

As mentioned above, the set of requirements 515 specifies a high resiliency requirement and a high mobility requirement between the SCs 505-1, 505-2 of the first spectrum band. Assuming that the high resiliency requirement of the set of requirements 515 corresponds to a hard constraint, the server 410-3 and the pod 420-15 are assigned to the SC 505-1, and the server 410-1 and the pod 420-1 are assigned to the SC 505-2. Stated another way, the SCs 505-1, 505-2 are assigned to different servers 410-3, 410-1 to meet the high resiliency requirement.

In an alternate implementation, the resiliency requirement of the set of requirements corresponds to a soft constraint. Based on the resiliency requirement (and in some cases, a priority of the resiliency requirement relative to the mobility requirement) the SCs 505-1, 505-2 may be assigned to a same server. The SCs 505-1, 505-2 may be assigned to a same pod or to different pods on the same server.

As mentioned above, the sets of requirements 520-1, 520-2, 520-3 specifies a low resiliency requirement and a high mobility requirement between the SCs 510-1, . . . , 510-4 of the second spectrum band. Assuming that the low resiliency requirement of the sets of requirements 520-1, 520-2, 520-3 corresponds to a soft constraint (and in some cases, based on a priority of the resiliency requirement relative to the mobility requirement), the server 410-2 is assigned to the SCs 510-1, . . . , 510-4. Considering the maximum capacity of the pods (two SCs each), the pod 420-5 is assigned to the SCs 510-1, 510-2, and the pod 420-6 is assigned to the SCs 510-3, 510-4. In total, three (3) servers 410-1, 410-2, 410-3 and four (4) pods 420-1, 420-5, 420-6, 420-15 are assigned to the six (6) SCs 505-1, 505-2, 510-1, . . . , 510-4.

In an alternate implementation, the resiliency requirement of the sets of requirements 520-1, 520-2, 520-3 corresponds to a hard constraint such that separate servers are assigned to the SCs 510-1, . . . , 510-4. In yet another alternate implementation, the resiliency requirement corresponds to a soft constraint, and the priority of the resiliency requirement relative to the mobility requirement is different, such that different servers and/or pods are assigned to the SCs 510-1, . . . , 510-4.

The set of requirements 525-1, 525-2, 525-3, 525-4 specifies a medium mobility requirement (affinity) and a high resiliency requirement (anti-affinity), which contradict each other. If the resiliency requirement corresponds a hard constraint, it will be satisfied at all times (assuming enough capacity, number of servers), and the assignment will be done such that overlapping low-band SCs and high-band SCs do not share same server. If the resiliency requirement corresponds to a soft constraint, the assignment will be done according to the priority/penalty values of the different requirements.

FIG. 5B illustrates an exemplary assignment of computing resources to support a plurality of sector carriers of a mobile network, according to one or more embodiments. The features in diagram 550 may be used in conjunction with other embodiments, for example, using the hierarchy of computing resources shown in FIG. 4.

In the example shown in the diagram 550, the mobility requirement again corresponds to a soft affinity constraint and the resiliency requirement corresponds to a hard anti-affinity constraint. However, each server has a maximum capacity of two (2) pods, and each pod has a maximum capacity of one (1) SC.

As mentioned above, the set of requirements 515 specifies a high resiliency requirement and a high mobility requirement between the SCs 505-1, 505-2 of the first spectrum band. Assuming that the high resiliency requirement of the set of requirements 515 corresponds to a hard constraint, the server 410-1 and the pod 420-1 are assigned to the SC 505-1, and the server 410-3 and the pod 420-16 are assigned to the SC 505-2. Stated another way, the SCs 505-1, 505-2 are assigned to different servers 410-1, 410-3 to meet the high resiliency requirement.

In an alternate implementation, the resiliency requirement of the set of requirements corresponds to a soft constraint. Based on the resiliency requirement (and in some cases, a priority of the resiliency requirement relative to the mobility requirement) the SCs 505-1, 505-2 may be assigned to a same server. The SCs 505-1, 505-2 may be assigned to a same pod or to different pods on the same server.

As mentioned above, the sets of requirements 520-1, 520-2, 520-3 specifies a low resiliency requirement and a high mobility requirement between the SCs 510-1, . . . , 510-4 of the second spectrum band. Assuming that the low resiliency requirement of the sets of requirements 520-1, 520-2, 520-3 corresponds to a soft constraint (and in some cases, based on a priority of the resiliency requirement relative to the mobility requirement), the server 410-2 is assigned to the SCs 510-1, 510-2, and the server 410-4 is assigned to the SCs 510-3, 510-4. Considering the maximum capacity of the pods (1 SC each), the pod 420-5 is assigned to the SC 510-1, the pod 420-6 is assigned to SC 510-2, the pod 420-17 is assigned to the SC 510-3, and the pod 420-18 is assigned to the SC 510-4. In total, four (4) servers 410-1, . . . , 410-4 and six (6) pods 420-1, 420-5, 420-6, 420-16, 420-17, 420-18 are assigned to the six (6) SCs 505-1, 505-2, 510-1, . . . , 510-4.

In an alternate implementation, the resiliency requirement of the sets of requirements 520-1, 520-2, 520-3 corresponds to a hard constraint such that separate servers are assigned to the SCs 510-1, . . . , 510-4. In yet another alternate implementation, the resiliency requirement corresponds to a soft constraint, and the priority of the resiliency requirement relative to the mobility requirement is different, such that different servers and/or pods are assigned to the SCs 510-1, . . . , 510-4.

Refer now to FIG. 6A, which illustrates connectivity between network devices (NDs) within an exemplary network, as well as three exemplary implementations of the NDs, according to some embodiments of the invention. The features illustrated in FIG. 6A may be used in conjunction with other embodiments described herein. For example, some or all of the network devices 600A, . . . , 600-H may be examples of the electronic device 225 of FIG. 2, including a sector carrier resource assignment service 240 and/or an LP model service 245. As used herein, a network device is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

FIG. 6A shows NDs 600A-H, and their connectivity by way of lines between 600A-600B, 600B-600C, 600C-600D, 600D-600E, 600E-600F, 600F-600G, and 600A-600G, as well as between 600H and each of 600A, 600C, 600D, and 600G. These NDs are physical devices, and the connectivity between these NDs can be wireless or wired (often referred to as a link). An additional line extending from NDs 600A, 600E, and 600F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated-circuits (ASICs) and a special-purpose operating system (OS); and 2) a general-purpose network device 604 that uses common off-the-shelf (COTS) processors and a standard OS.

The special-purpose network device 602 includes networking hardware 610 comprising a set of one or more processor(s) 612 (e.g., one example of the one or more processors 210-1, 210-2, which in some cases includes neuromorphic hardware 220-1, 220-2), forwarding resource(s) 614 (which typically include one or more ASICs and/or network processors), and physical network interfaces (NIs) 616 (through which network connections are made, such as those shown by the connectivity between NDs 600A-H), as well as non-transitory machine readable storage media 618 having stored therein networking software 620. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A). In some embodiments, the functionality of the QUBO problem solver service 230-1, 230-2 may be included in the software 650. In other embodiments, the QUBO problem solver service 230-1, 230-2 may be implemented separate from the software 650 within the non-transitory machine readable storage media 648.

The special-purpose network device 602 is often physically and/or logically considered to include: 1) a ND control plane 624 (sometimes referred to as a control plane) comprising the processor(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the processor(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

FIG. 6B illustrates an exemplary way to implement the special-purpose network device 602 according to some embodiments of the invention. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general-purpose network device 604 includes hardware 640 comprising a set of one or more processor(s) 642 (which are often COTS processors) (e.g., another example of the one or more processors 230) and physical NIs 646, as well as non-transitory machine-readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization. For example, in one such alternative embodiment the virtualization layer 654 represents the kernel of an operating system (or a shim executing on a base operating system) that allows for the creation of multiple instances 662A-R called software containers that may each be used to execute one (or more) of the sets of applications 664A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 654 represents a hypervisor (sometimes referred to as a virtual machine monitor (VMM)) or a hypervisor executing on top of a host operating system, and each of the sets of applications 664A-R is run on top of a guest operating system within an instance 662A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels and sets of applications that are run in different software containers).

The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual network element(s) 660A-R.

The virtual network element(s) 660A-R perform similar functionality to the virtual network element(s) 630A-R—e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 662A-R to VNEs also apply to embodiments where such a finer level of granularity and/or unikernels are used.

In certain embodiments, the virtualization layer 654 includes a virtual switch that provides similar forwarding services as a physical Ethernet switch. Specifically, this virtual switch forwards traffic between instances 662A-R and the physical NI(s) 646, as well as optionally between the instances 662A-R; in addition, this virtual switch may enforce network isolation between the VNEs 660A-R that by policy are not permitted to communicate with each other (e.g., by honoring virtual local area networks (VLANs)).

The third exemplary ND implementation in FIG. 6A is a hybrid network device 606, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 630A-R, VNEs 660A-R, and those in the hybrid network device 606) receives data on the physical NIs (e.g., 616, 646) and forwards that data out the appropriate ones of the physical NIs (e.g., 616, 646). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 6C illustrates various exemplary ways in which VNEs may be coupled according to some embodiments of the invention. FIG. 6C shows VNEs 670A.1-670A.P (and optionally VNEs 670A.Q-670A.R) implemented in ND 600A and VNE 670H.1 in ND 600H. In FIG. 6C, VNEs 670A.1-P are separate from each other in the sense that they can receive packets from outside ND 600A and forward packets outside of ND 600A; VNE 670A.1 is coupled with VNE 670H.1, and thus they communicate packets between their respective NDs; VNE 670A.2-670A.3 may optionally forward packets between themselves without forwarding them outside of the ND 600A; and VNE 670A.P may optionally be the first in a chain of VNEs that includes VNE 670A.Q followed by VNE 670A.R (this is sometimes referred to as dynamic service chaining, where each of the VNEs in the series of VNEs provides a different service—e.g., one or more layer 4-7 network services). While FIG. 6C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 6A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 6A may also host one or more such servers (e.g., in the case of the general purpose network device 604, one or more of the software instances 662A-R may operate as servers; the same would be true for the hybrid network device 606; in the case of the special-purpose network device 602, one or more such servers could also be run on a virtualization layer executed by the processor(s) 612); in which case the servers are said to be co-located with the VNEs of that ND.

A virtual network is a logical abstraction of a physical network (such as that in FIG. 6A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 6D illustrates a network with a single network element on each of the NDs of FIG. 6A, and within this straight forward approach contrasts a traditional distributed approach (commonly used by traditional routers) with a centralized approach for maintaining reachability and forwarding information (also called network control), according to some embodiments of the invention. Specifically, FIG. 6D illustrates network elements (NEs) 670A-H with the same connectivity as the NDs 600A-H of FIG. 6A.

FIG. 6D illustrates that the distributed approach 672 distributes responsibility for generating the reachability and forwarding information across the NEs 670A-H; in other words, the process of neighbor discovery and topology discovery is distributed.

For example, where the special-purpose network device 602 is used, the control communication and configuration module(s) 632A-R of the ND control plane 624 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 670A-H (e.g., the processor(s) 612 executing the control communication and configuration module(s) 632A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 624. The ND control plane 624 programs the ND forwarding plane 626 with information (e.g., adjacency and route information) based on the routing structure(s). For example, the ND control plane 624 programs the adjacency and route information into one or more forwarding table(s) 634A-R (e.g., Forwarding Information Base (FIB), Label Forwarding Information Base (LFIB), and one or more adjacency structures) on the ND forwarding plane 626. For layer 2 forwarding, the ND can store one or more bridging tables that are used to forward data based on the layer 2 information in that data. While the above example uses the special-purpose network device 602, the same distributed approach 672 can be implemented on the general purpose network device 604 and the hybrid network device 606.

FIG. 6D illustrates that a centralized approach 674 (also known as software defined networking (SDN)) that decouples the system that makes decisions about where traffic is sent from the underlying systems that forwards traffic to the selected destination. The illustrated centralized approach 674 has the responsibility for the generation of reachability and forwarding information in a centralized control plane 676 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 676 has a south bound interface 682 with a data plane 680 (sometime referred to the infrastructure layer, network forwarding plane, or forwarding plane (which should not be confused with a ND forwarding plane)) that includes the NEs 670A-H (sometimes referred to as switches, forwarding elements, data plane elements, or nodes). The centralized control plane 676 includes a network controller 678, which includes a centralized reachability and forwarding information module 679 that determines the reachability within the network and distributes the forwarding information to the NEs 670A-H of the data plane 680 over the south bound interface 682 (which may use the OpenFlow protocol). Thus, the network intelligence is centralized in the centralized control plane 676 executing on electronic devices that are typically separate from the NDs.

For example, where the special-purpose network device 602 is used in the data plane 680, each of the control communication and configuration module(s) 632A-R of the ND control plane 624 typically include a control agent that provides the VNE side of the south bound interface 682. In this case, the ND control plane 624 (the processor(s) 612 executing the control communication and configuration module(s) 632A-R) performs its responsibility for participating in controlling how data (e.g., packets) is to be routed (e.g., the next hop for the data and the outgoing physical NI for that data) through the control agent communicating with the centralized control plane 676 to receive the forwarding information (and in some cases, the reachability information) from the centralized reachability and forwarding information module 679 (it should be understood that in some embodiments of the invention, the control communication and configuration module(s) 632A-R, in addition to communicating with the centralized control plane 676, may also play some role in determining reachability and/or calculating forwarding information—albeit less so than in the case of a distributed approach; such embodiments are generally considered to fall under the centralized approach 674, but may also be considered a hybrid approach).

While the above example uses the special-purpose network device 602, the same centralized approach 674 can be implemented with the general purpose network device 604 (e.g., each of the VNE 660A-R performs its responsibility for controlling how data (e.g., packets) is to be routed (e.g., the next hop for the data and the outgoing physical NI for that data) by communicating with the centralized control plane 676 to receive the forwarding information (and in some cases, the reachability information) from the centralized reachability and forwarding information module 679; it should be understood that in some embodiments of the invention, the VNEs 660A-R, in addition to communicating with the centralized control plane 676, may also play some role in determining reachability and/or calculating forwarding information—albeit less so than in the case of a distributed approach) and the hybrid network device 606. In fact, the use of SDN techniques can enhance the NFV techniques typically used in the general-purpose network device 604 or hybrid network device 606 implementations as NFV is able to support SDN by providing an infrastructure upon which the SDN software can be run, and NFV and SDN both aim to make use of commodity server hardware and physical switches.

FIG. 6D also shows that the centralized control plane 676 has a north bound interface 684 to an application layer 686, in which resides application(s) 688. The centralized control plane 676 has the ability to form virtual networks 692 (sometimes referred to as a logical forwarding plane, network services, or overlay networks (with the NEs 670A-H of the data plane 680 being the underlay network)) for the application(s) 688. Thus, the centralized control plane 676 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 6D shows the distributed approach 672 separate from the centralized approach 674, the effort of network control may be distributed differently or the two combined in certain embodiments of the invention. For example: 1) embodiments may generally use the centralized approach (SDN) 674, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 674, but may also be considered a hybrid approach.

While FIG. 6D illustrates the simple case where each of the NDs 600A-H implements a single NE 670A-H, it should be understood that the network control approaches described with reference to FIG. 6D also work for networks where one or more of the NDs 600A-H implement multiple VNEs (e.g., VNEs 630A-R, VNEs 660A-R, those in the hybrid network device 606). Alternatively or in addition, the network controller 678 may also emulate the implementation of multiple VNEs in a single ND. Specifically, instead of (or in addition to) implementing multiple VNEs in a single ND, the network controller 678 may present the implementation of a VNE/NE in a single ND as multiple VNEs in the virtual networks 692 (all in the same one of the virtual network(s) 692, each in different ones of the virtual network(s) 692, or some combination). For example, the network controller 678 may cause an ND to implement a single VNE (a NE) in the underlay network, and then logically divide up the resources of that NE within the centralized control plane 676 to present different VNEs in the virtual network(s) 692 (where these different VNEs in the overlay networks are sharing the resources of the single VNE/NE implementation on the ND in the underlay network).

On the other hand, FIGS. 6E and 6F respectively illustrate exemplary abstractions of NEs and VNEs that the network controller 678 may present as part of different ones of the virtual networks 692. FIG. 6E illustrates the simple case of where each of the NDs 600A-H implements a single NE 670A-H (see FIG. 6D), but the centralized control plane 676 has abstracted multiple of the NEs in different NDs (the NEs 670A-C and G-H) into (to represent) a single NE 6701 in one of the virtual network(s) 692 of FIG. 6D, according to some embodiments of the invention. FIG. 6E shows that in this virtual network, the NE 6701 is coupled to NE 670D and 670F, which are both still coupled to NE 670E.

FIG. 6F illustrates a case where multiple VNEs (VNE 670A.1 and VNE 670H.1) are implemented on different NDs (ND 600A and ND 600H) and are coupled to each other, and where the centralized control plane 676 has abstracted these multiple VNEs such that they appear as a single VNE 670T within one of the virtual networks 692 of FIG. 6D, according to some embodiments of the invention. Thus, the abstraction of a NE or VNE can span multiple NDs.

While some embodiments of the invention implement the centralized control plane 676 as a single entity (e.g., a single instance of software running on a single electronic device), alternative embodiments may spread the functionality across multiple entities for redundancy and/or scalability purposes (e.g., multiple instances of software running on different electronic devices).

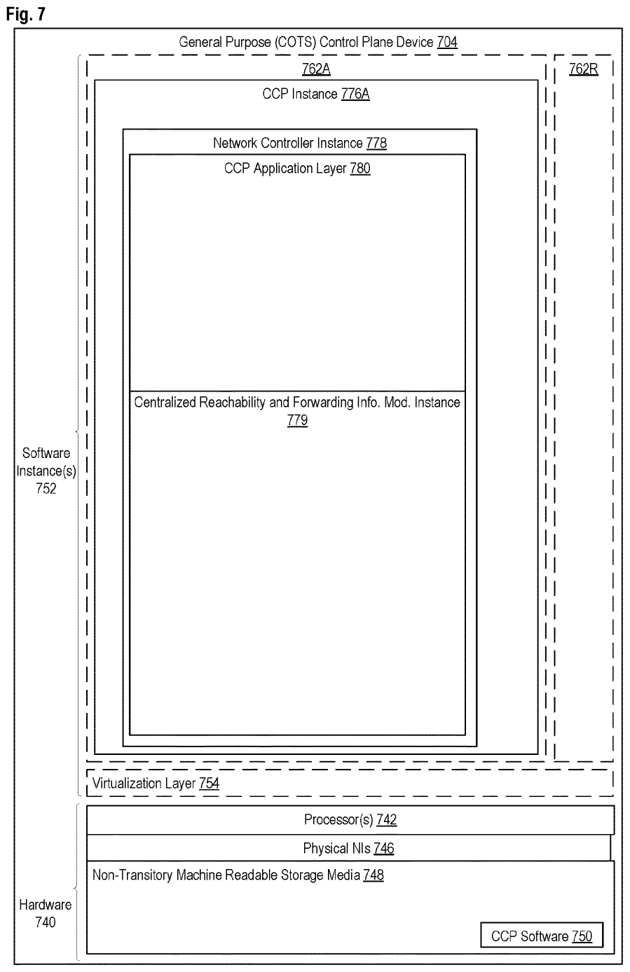

Similar to the network device implementations, the electronic device(s) running the centralized control plane 676, and thus the network controller 678 including the centralized reachability and forwarding information module 679, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 7 illustrates, a general-purpose control plane device 704 including hardware 740 comprising a set of one or more processor(s) 742 (which are often COTS processors) and physical NIs 746, as well as non-transitory machine-readable storage media 748 having stored therein centralized control plane (CCP) software 750.

In embodiments that use compute virtualization, the processor(s) 742 typically execute software to instantiate a virtualization layer 754 (e.g., in one embodiment the virtualization layer 754 represents the kernel of an operating system (or a shim executing on a base operating system) that allows for the creation of multiple instances 762A-R called software containers (representing separate user spaces and also called virtualization engines, virtual private servers, or jails) that may each be used to execute a set of one or more applications; in another embodiment the virtualization layer 754 represents a hypervisor (sometimes referred to as a virtual machine monitor (VMM)) or a hypervisor executing on top of a host operating system, and an application is run on top of a guest operating system within an instance 762A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 740, directly on a hypervisor represented by virtualization layer 754 (in which case the unikernel is sometimes described as running within a LibOS virtual machine), or in a software container represented by one of instances 762A-R). Again, in embodiments where compute virtualization is used, during operation an instance of the CCP software 750 (illustrated as CCP instance 776A) is executed (e.g., within the instance 762A) on the virtualization layer 754. In embodiments where compute virtualization is not used, the CCP instance 776A is executed, as a unikernel or on top of a host operating system, on the “bare metal” general purpose control plane device 704. The instantiation of the CCP instance 776A, as well as the virtualization layer 754 and instances 762A-R if implemented, are collectively referred to as software instance(s) 752.

In some embodiments, the CCP instance 776A includes a network controller instance 778. The network controller instance 778 includes a centralized reachability and forwarding information module instance 779 (which is a middleware layer providing the context of the network controller 678 to the operating system and communicating with the various NEs), and an CCP application layer 780 (sometimes referred to as an application layer) over the middleware layer (providing the intelligence required for various network operations such as protocols, network situational awareness, and user-interfaces). At a more abstract level, this CCP application layer 780 within the centralized control plane 676 works with virtual network view(s) (logical view(s) of the network) and the middleware layer provides the conversion from the virtual networks to the physical view.

The centralized control plane 676 transmits relevant messages to the data plane 680 based on CCP application layer 780 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 7 or more) in the packet headers. Different NDs/NEs/VNEs of the data plane 680 may receive different messages, and thus different forwarding information. The data plane 680 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 680, the packet (or a subset of the packet header and content) is typically forwarded to the centralized control plane 676. The centralized control plane 676 will then program forwarding table entries into the data plane 680 to accommodate packets belonging to the flow of the unknown packet. Once a specific forwarding table entry has been programmed into the data plane 680 by the centralized control plane 676, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

A virtual circuit (VC), synonymous with virtual connection and virtual channel, is a connection oriented communication service that is delivered by means of packet mode communication. Virtual circuit communication resembles circuit switching, since both are connection oriented, meaning that in both cases data is delivered in correct order, and signaling overhead is required during a connection establishment phase. Virtual circuits may exist at different layers. For example, at layer 4, a connection oriented transport layer datalink protocol such as Transmission Control Protocol (TCP) may rely on a connectionless packet switching network layer protocol such as IP, where different packets may be routed over different paths, and thus be delivered out of order. Where a reliable virtual circuit is established with TCP on top of the underlying unreliable and connectionless IP protocol, the virtual circuit is identified by the source and destination network socket address pair, i.e. the sender and receiver IP address and port number. However, a virtual circuit is possible since TCP includes segment numbering and reordering on the receiver side to prevent out-of-order delivery. Virtual circuits are also possible at Layer 3 (network layer) and Layer 2 (datalink layer); such virtual circuit protocols are based on connection oriented packet switching, meaning that data is always delivered along the same network path, i.e. through the same NEs/VNEs. In such protocols, the packets are not routed individually and complete addressing information is not provided in the header of each data packet; only a small virtual channel identifier (VCI) is required in each packet; and routing information is transferred to the NEs/VNEs during the connection establishment phase; switching only involves looking up the virtual channel identifier in a table rather than analyzing a complete address. Examples of network layer and datalink layer virtual circuit protocols, where data always is delivered over the same path: X.25, where the VC is identified by a virtual channel identifier (VCI); Frame relay, where the VC is identified by a VCI; Asynchronous Transfer Mode (ATM), where the circuit is identified by a virtual path identifier (VPI) and virtual channel identifier (VCI) pair; General Packet Radio Service (GPRS); and Multiprotocol label switching (MPLS), which can be used for IP over virtual circuits (Each circuit is identified by a label).

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

Each VNE (e.g., a virtual router, a virtual bridge (which may act as a virtual switch instance in a Virtual Private LAN Service (VPLS) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VoD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

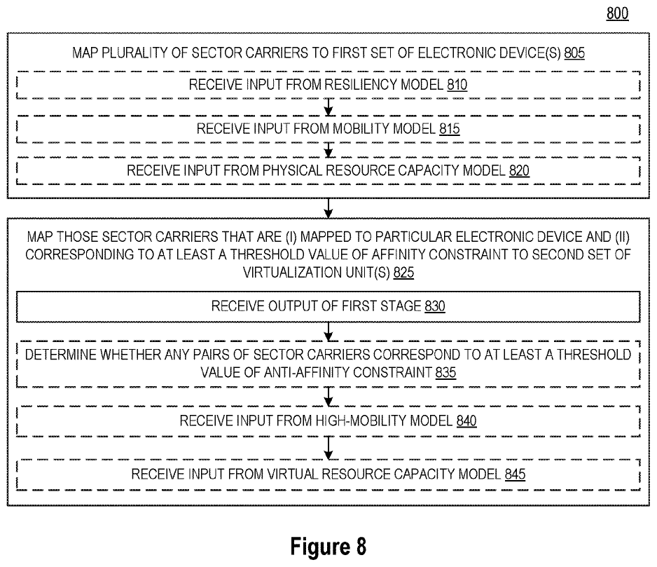

FIG. 8 illustrates a method 800 performed by an electronic device for determining whether an optimal solution exists for the linear programming model, according to one or more embodiments. The method 800 may be used in conjunction with other embodiments described herein, such as being performed by the sector carrier resource assignment service 240 as part of block 150 of method 100 of FIG. 1.

The method 800 begins at block 805, where the sector carrier resource assignment service 240 maps the plurality of sector carriers to a first set of the one or more electronic devices of the mobile network. In some embodiments, mapping the plurality of sector carriers to the first set comprises (at block 810) receiving an input from a resiliency model of the linear programming model, (at block 815) receiving an input from a mobility model of the linear programming model, and (at block 820) receiving an input from a physical resource capacity model of the linear programming model.

In some embodiments, mapping the plurality of sector carriers to the physical computing resources (i.e., the first set of the one or more electronic devices) is performed in a first stage of an optimization solver of the sector carrier resource assignment service 240. Such an implementation is illustrated in diagram 900 of FIG. 9, where an optimization solver 935 includes Stage I processing 940 and Stage II processing 945.

Thus, the optimization solver 935 may solve the hierarchical allocation problem as two distinct sub-problems. The Stage I processing 940 allocates the sector carriers to particular electronic device(s) (e.g., server(s)) of the mobile network, while the Stage II processing 945 distributes the assigned sector carriers into virtualization unit(s) (e.g., pods). In some embodiments, the Stage I processing 940 operates using an assumption of a single virtualization unit per electronic device, where the single virtualization unit can provide the entire resource capacity of the electronic device. The assumption of a single virtualization unit allows sector carriers with high mobility requirements to be prioritized over sector carriers with medium mobility requirements.

In some embodiments, the virtual resource capacity constraints are introduced in the Stage II processing 945. Beneficially, the two-stage approach reduces the number of optimization variables to be solved by the optimization solver 935 by a factor of the number of possible virtualization units per electronic device, which typically provides an order of magnitude in complexity gain. In this way, the two-stage approach may reduce the computing resources (e.g., CPU cycles, memory) required to perform the optimization, and may be completed more quickly.

The LP model service 245 operates to construct the LP model 905. In some embodiments, the LP model service 245 acquires information describing SC requirements of the mobile network (e.g., a SC assignment request) and a description of the computing resources of the mobile network. In some embodiments, the LP model 905 includes two decision variables for each sector carrier:

$${x}_{s}^{SC} ∈ \{ 0 , 1 \} \qquad ( 13 )$$

that indicates whether sector carrier SC is assigned to a server s, and

$${y}_{p}^{SC} ∈ \{ 0 , 1 \} \qquad ( 14 )$$

that indicates whether the sector carrier SC is assigned to a pod p.

The capacity model 920 of the LP model 905 includes a physical resource capacity model 925 and a virtual resource capacity model 930. The physical resource capacity model 925 models a capacity limit as a number of SCs supported or as a CPU capacity:

$${\sum }_{∀ S {C}_{n} ϵ SCs} {x}_{s}^{{SC}_{n}} \cdot {required\_cpu}_{S {C}_{n}} \leq {max\_CPU}_{s} ∀ s ∈ servers \qquad ( 15 )$$

Similarly, the virtual resource capacity model 930 models a capacity limit as a number of SCs supported or as a CPU capacity (e.g., the amount of CPU that is available and may be allocated):

$${\sum }_{∀ S {C}_{n} ϵ SCs} {y}_{p}^{{SC}_{n}} \cdot {required\_cpu}_{S {C}_{n}} \leq {max\_CPU}_{p} ∀ p ∈ pods \qquad ( 16 )$$

Each SC may be assigned to only one server and only one pod, represented by the following constraints in the LP model 905:

$${\sum }_{∀ i ϵ servers} {x}_{i}^{{SC}_{n}} = 1 ∀ {SC}_{n} ∈ SCs \qquad ( 17 )$$

$${\sum }_{∀ j ϵ pods} {y}_{j}^{{SC}_{n}} = 1 ∀ {SC}_{n} ∈ S C s \qquad ( 18 )$$

Thus, the Stage I processing 940 receives inputs from the resiliency model 910, the mobility model 915, and the physical resource capacity model 925. The Stage I processing 940 also applies equation (17). The Stage I processing 940 generates a mapping 950 of the SCs to the servers.

Returning to method 800, at block 825, the sector carrier resource assignment service 240 maps those sector carriers of the plurality of sector carriers that are (i) mapped to a particular electronic device of the first set, and (ii) corresponding to at least a threshold value of the affinity constraint, to a second set of one or more virtualization units of the virtualized resources.

In some embodiments, mapping those sector carriers of the plurality of sector carriers to a second set of one or more virtualization units comprises (at block 830) receiving an output of the first stage, (at block 835) determining whether any pairs of those sector carriers correspond to at least a threshold value of the anti-affinity constraint, such that those pairs should be assigned to separate virtualization units of the one or more virtualization units, (at block 840) receiving an input from a high-mobility model of the LP model 905, and (at block 845), receiving an input from the virtual resource capacity model 930 of the LP model 905.

In the diagram 900, the Stage II processing 945 receives the mapping 950 from the Stage I processing 940, inputs from the high-mobility model 915 (e.g., according to the Equations (9)-(11) above), and the virtual resource capacity model 930 (e.g., according to the Equation (16) above). The Stage II processing 945 also applies equation (18).

In some embodiments, the Stage II processing 945 generates a mapping for the SCs mapped to a single server having high-mobility requirements between them. The Stage II processing 945 creates a new pod instance for a SC, or sharing a same instance between multiple SCs. The mapping may be output by the Stage II processing 945 as an optimal solution 955.

In some embodiments, the Stage II processing 945 also receives an input from the resiliency model 910 where the resiliency requirement is represented as a soft constraint (e.g., according to Equations (2)-(4) above). In this way, those SCs having high-resiliency requirements may be assigned to different pods.

In some embodiments, the block 825 repeats for each of the servers represented in the mapping 950. The method 800 ends following completion of the block 825.

FIG. 10A illustrates an assignment of sector carriers using an exemplary two-stage optimization, and FIG. 10B illustrates an assignment of sector carriers using an exemplary one-stage optimization, according to one or more embodiments. More specifically, in the example, twelve (12) sector carriers (having indices 0, 1, . . . , 11) are allocated to a number of pods 420-0, . . . , 420-3 implemented among two servers 410-0, 410-1 (having indices 0, 1). In the example, each of the servers 410-0, 410-1 has a maximum capacity of ten (10) SCs, and each of the pods 420-0, . . . , 420-3 has a maximum capacity of four (4) SCs. Each pairing of different ones of the sector carriers has a high-mobility requirement.

Using the two-stage approach illustrated in diagram 1000 of FIG. 10A, in the Stage I processing ten (10) SCs are assigned to the Server 0, which ensures the largest possible clustering of high-mobility clusters and corresponding to a larger mobility value. The remaining two (2) SCs are assigned to the Server 1. In the Stage II processing, the SCs on the Servers 0, 1 are assigned to pods. As shown, SCs 2, 10 are assigned to Pod 0, SCs 1, 3, 6, 11 are assigned to Pod 2, and SCs 5, 7, 8, 9 are assigned to Pod 3 on Server 0. SCs 0, 4 are assigned to Pod 1 on Server 1.

For values of penalty terms pMₚ=100 and pMₛ=10. the overall penalty for violating the high-mobility constraints is 25320. For example, the twelve sector carriers have high-mobility requirements therebetween. Each time a high-mobility requirement is satisfied, a penalty of (100+10) is added to the objective function. Each time a high-mobility requirement is downgraded to a medium-mobility requirement, a penalty of (200+10) is added to the objective function. Each time a high-mobility requirement is not satisfied (or is downgraded to a low-mobility requirement), a penalty of (200+20) is added to the objective function.

Further, the number of high-mobility requirements that are downgraded to medium-mobility requirements is sixty-four (64) requirements, as the Pod 0 at the Server 0 hosting two SCs has a relatively lesser value than another pod at another server hosting 4 SCs. For example, to add more SCs to a particular server, a high-mobility requirement may be downgraded to a medium-mobility requirement so that SCs may be assigned to a same server (but not necessarily a same pod). Similarly, downgrading a medium-mobility requirement to a low-mobility requirement permits SCs may be assigned to different servers.

Using the single-stage approach illustrated in diagram 1050 of FIG. 10B (e.g., using the LP model 305 of FIG. 3), the capacity of the servers and capacity of the pods are considered together. Thus, the SCs 2, 3, 7, 8 are assigned to Pod 0 on Server 0, the SCs 1, 4, 5, 10 are assigned to Pod 1 on Server 1, and the SCs 0, 6, 9, 11 are assigned to Pod 2 on Server 1.

For the same values of the penalty terms (pMₚ=100 and pMₛ=10), the overall penalty for violating the high-mobility constraints is 24760, and the number of high-mobility requirements that are downgraded to medium-mobility requirements is thirty-six (36) requirements. Thus, the single-stage approach generates an optimal result for the small-scale example.

The two-stage approach generally operates as an approximation for global optimization, generating near-optimal results and working well for large-scale scenarios.

The two-stage approach may provide a number of advantages. As discussed above, the two-stage approach reduces the number of optimization variables to be solved by a factor of the number of possible pods per server, which typically provides an order of magnitude in complexity gain. In this way, the two-stage approach may reduce the computing resources (e.g., CPU cycles, memory) required to perform the optimization, and may be completed more quickly.

By transforming the sector carrier resource assignment problem into the LP model 905 that is based on the computing resource information, competing constraints (e.g., affinity constraint(s) and anti-affinity constraint(s)), and/or the information describing the sector carriers of the mobile network 200, an optimal solution may be determined for many configurations of servers and pods in the mobile network 200. Notably, the optimal solution reflects both resource availability and service-related requirements. The computing resources needed to support the sector carriers can be defined per demand (e.g., sector load), and any preferences about prioritization of the different requirements can be flexibly configured. The LP model 905 accommodates the usage of capacity limits, connection limits, or configurable combinations of both at the server and pod level.

Using the resource assignment according to the optimal solution reduces the number of servers that are required to support the sector carriers of the mobile network 200. In some cases, this can result in a lower cost implementation of the mobile network 200, using fewer servers and/or less expensive servers (e.g., offering fewer computing resources). A reduced number of servers also results in a reduced energy consumption of the mobile network 200, which may also reduce operating costs. Use of the LP model 905 may require fewer computing resources (e.g., CPU cycles, memory) to produce optimal solutions when compared to existing approaches such as mixed-integer (linear) programming models, which may further reduce the energy consumption of the mobile network 200. Use of the LP model 905 may allow the optimal solutions to be produced more quickly than existing approaches, making the LP model 905 more suitable for the dynamic capabilities of the mobile network 200.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method performed by an electronic device for assigning computing resources, provided by one or more electronic devices of a mobile network, to support a plurality of sector carriers of the mobile network, the method comprising:
acquiring information describing the computing resources, the computing resources including virtualized resources at one or more levels of virtualization;
constructing a linear programming model based at least on the information, an affinity constraint between different sector carriers of pairs of the plurality of sector carriers, and an anti-affinity constraint between the different sector carriers of the pairs of the plurality of sector carriers, wherein the linear programming model includes one or more penalty terms corresponding to one or both of the affinity constraint and the anti-affinity constraint;
determining whether an optimal solution exists for the linear programming model, wherein determining whether the optimal solution exists comprises:
mapping the plurality of sector carriers to a first set of the one or more electronic devices; and
mapping those sector carriers of the plurality of sector carriers that are mapped to a particular electronic device of the first set, and corresponding to at least a threshold value of the affinity constraint, to a second set of one or more virtualization units of the virtualized resources; and
when the optimal solution exists, generating an assignment plan for the plurality of sector carriers corresponding to the optimal solution.

2. The method of claim 1, wherein mapping those sector carriers of the plurality of sector carriers to a second set of one or more virtualization units comprises:
determining whether any pairs of those sector carriers correspond to at least a threshold value of the anti-affinity constraint, such that those pairs should be assigned to separate virtualization units of the one or more virtualization units.

3. The method of claim 1, wherein mapping the plurality of sector carriers to the first set comprises receiving, at a first stage of an optimization solver of the electronic device, inputs from:
a resiliency model of the linear programming model;
a mobility model of the linear programming model; and
a physical resource capacity model of the linear programming model.

4. The method of claim 3, wherein mapping those sector carriers of the plurality of sector carriers to a second set of one or more virtualization units comprises receiving, at a second stage of the optimization solver, inputs from:
a high-mobility model of the linear programming model;
a virtual resource capacity model of the linear programming model; and
an output of the first stage.

5. The method of claim 1,
wherein the anti-affinity constraint represents a resiliency requirement between the different sector carriers of the pairs, and
wherein the affinity constraint represents a mobility requirement between the different sector carriers of the pairs.

6. The method of claim 1, wherein the anti-affinity constraint requires the different sector carriers to be assigned to different electronic devices of the mobile network.

7. The method of claim 1, wherein the plurality of sector carriers comprises:
one or more first sector carriers corresponding to a first spectrum band, and
one or more second sector carriers corresponding to a second spectrum band.

8. The method of claim 1, wherein the information comprises one or more capacity constraints of the computing resources.

9. The method of claim 1, further comprising:
when the optimal solution does not exist, generating a report that includes one or more adjustments to one or more of: the affinity constraint, the anti-affinity constraint, and a capacity constraint that would permit an optimal solution to exist.

10. A non-transitory, machine-readable storage medium comprising computer program code which, when executed by a computer, carries out operations for assigning computing resources, provided by one or more electronic devices of a mobile network, to support a plurality of sector carriers of the mobile network, the operations comprising:
acquiring information describing the computing resources, the computing resources including virtualized resources at one or more levels of virtualization;
constructing a linear programming model based at least on the information, an affinity constraint between different sector carriers of pairs of the plurality of sector carriers, and an anti-affinity constraint between the different sector carriers of the pairs of the plurality of sector carriers, wherein the linear programming model includes one or more penalty terms corresponding to one or both of the affinity constraint and the anti-affinity constraint;
determining whether an optimal solution exists for the linear programming model, wherein determining whether the optimal solution exists comprises:
mapping the plurality of sector carriers to a first set of the one or more electronic devices; and
mapping those sector carriers of the plurality of sector carriers that are (i) mapped to a particular electronic device of the first set, and (ii) corresponding to at least a threshold value of the affinity constraint, to a second set of one or more virtualization units of the virtualized resources; and
when the optimal solution exists, generating an assignment plan for the plurality of sector carriers corresponding to the optimal solution.

11. An electronic device comprising:
a machine-readable medium comprising computer program code; and
one or more processors to execute the computer program code to perform operations for assigning computing resources, provided by one or more electronic devices of a mobile network, to support a plurality of sector carriers of the mobile network, the operations to:
acquire information describing the computing resources, the computing resources including virtualized resources at one or more levels of virtualization;
construct a linear programming model based at least on the information, an affinity constraint between different sector carriers of pairs of the plurality of sector carriers, and an anti-affinity constraint between the different sector carrier of the pairs of the plurality of sector carriers, wherein the linear programming model includes one or more penalty terms corresponding to one or both of the affinity constraint and the anti-affinity constraint;
determining determine whether an optimal solution exists for the linear programming model, wherein to determine whether the optimal solution exists comprises operations to:
map the plurality of sector carriers to a first set of the one or more electronic devices; and
map those sector carriers of the plurality of sector carriers that are (i) mapped to a particular electronic device of the first set, and (ii) corresponding to at least a threshold value of the affinity constraint, to a second set of one or more virtualization units of the virtualized resources; and
when the optimal solution exists, generating generate an assignment plan for the plurality of sector carriers corresponding to the optimal solution.

12. The electronic device of claim 11, wherein to map those sector carriers of the plurality of sector carriers to a second set of one or more virtualization units comprises operations to:
determine whether any pairs of those sector carriers correspond to at least a threshold value of the anti-affinity constraint, such that those pairs should be assigned to separate virtualization units of the one or more virtualization units.

13. The electronic device of claim 11, wherein to map the plurality of sector carriers to the first set comprises receiving, at a first stage of an optimization solver of the electronic device, inputs from:
a resiliency model of the linear programming model;
a mobility model of the linear programming model; and
a physical resource capacity model of the linear programming model.

14. The electronic device of claim 13, wherein to map those sector carriers of the plurality of sector carriers to a second set of one or more virtualization units comprises receiving, at a second stage of the optimization solver, inputs from:
a high-mobility model of the linear programming model;
a virtual resource capacity model of the linear programming model; and
an output of the first stage.

15. The electronic device of claim 11,
wherein the anti-affinity constraint represents a resiliency requirement between the different sector carriers of the pairs, and
wherein the affinity constraint represents a mobility requirement between the different sector carriers of the pairs.

16. The electronic device of claim 11,
wherein the anti-affinity constraint requires the different sector carriers to be assigned to different electronic devices of the mobile network.

17. The electronic device of claim 11, wherein the plurality of sector carriers comprises:
one or more first sector carriers corresponding to a first spectrum band, and
one or more second sector carriers corresponding to a second spectrum band.

18. The electronic device of claim 11, wherein the information comprises one or more capacity constraints of the computing resources.

19. The electronic device of claim 11, wherein the operations further comprising:
when the optimal solution does not exist, to generate a report that includes one or more adjustments to one or more of: the affinity constraint, the anti-affinity constraint, and a capacity constraint that would permit an optimal solution to exist.

20. The non-transitory, machine-readable storage medium of claim 10, wherein mapping those sector carriers of the plurality of sector carriers to a second set of one or more virtualization units comprises:
determining whether any pairs of those sector carriers correspond to at least a threshold value of the anti-affinity constraint, such that those pairs should be assigned to separate virtualization units of the one or more virtualization units.
